(19) United States
(12) Patent Application Publication
(10) Pub. No.: US 2023/0003923 A1
(43) Pub. Date: Jan. 5, 2023

(54) ANGULAR FILTER

(71) Applicant: ISORG, Limoges CEDEX 3 (FR)

(72) Inventors: Wilfrid SCHWARTZ, GRENOBLE (FR); Benjamin BOUTHINON, GRENOBLE (FR); Audrey ROSA, GRENOBLE (FR); Jean-Yves GOMEZ, GRENOBLE (FR)

(21) Appl. No.: 17/782,558

(22) PCT Filed: Dec. 3, 2020
(86) PCT No.: PCT/EP2020/084543

§ 371 Date: Jun. 3, 2022

(30) Foreign Application Priority Data
Dec. 6, 2019 (FR) 1913892

(51) Int. Cl. G02B 3/00; G02B 5/20

(52) U.S. Cl. CPC G02B 3/0031; G02B 5/201

(57) ABSTRACT

An angular filter includes a first and a second array of plano-convex lenses and an array of openings. The planar surfaces of the lenses of the first array and of the second array face one another.

### RELATED APPLICATION

The present patent application claims the priority benefit of French patent application FR19/13892 which is herein incorporated by reference.

### FIELD

The present disclosure concerns an angular optical filter.

More particularly, the present disclosure concerns an angular filter intended to be used inside of an optical system, for example, an imaging system, or to be used to collimate the rays of a light source (directional illumination by organic light-emitting diode (OLED) and optical inspection).

### BACKGROUND

An angular filter is a device enabling to filter an incident radiation according to the incidence of this radiation and thus to block rays having an incidence greater than a desired angle, called maximum incidence angle.

Angular filters are frequently used in association with image sensors.

### SUMMARY OF THE INVENTION

There is a need to improve known angular filters.

An embodiment provides an angular filter comprising:
a first array of plano-convex lenses;
a second array of plano-convex lenses located between the first lens array and an image sensor; and
an array of openings,
the planar surfaces of the lenses of the first array and of the second array facing one another and the number of lenses of the second array being greater than the number of lenses of the first array.

An embodiment provides an angular filter comprising a first and a second array of plano-convex lenses and an array of openings, the planar surfaces of the lenses of the first array and of the second array facing one another.

According to an embodiment, the array of openings is formed in a layer made of a first resin opaque in the visible and infrared ranges.

According to an embodiment, the openings of the array are filled with air or with a material at least partially clear in the visible and infrared ranges.

According to an embodiment, the optical axis of each lens of the first array is aligned with the optical axis of a lens of the second array and the center of an opening of the array.

According to an embodiment, each opening of the array is associated with a single lens of the first array.

According to an embodiment, the image focal planes of the lenses of the first array coincide with the object focal planes of the lenses of the second array.

According to an embodiment, the number of lenses of the second array is greater than the number of lenses of the first array.

According to an embodiment, the lenses of the first array have a diameter greater than that of the lenses of the second array.

According to an embodiment, the array of openings is located between the first lens array and the second lens array.

According to an embodiment, the second lens array is located between the first lens array and the array of openings.

According to an embodiment, the lenses of the first array are on top of and in contact with a substrate.

An embodiment provides a method of manufacturing of an angular filter comprising, among others, the steps of:
depositing a film of a second resist;
forming by photolithography pads of second resist; and
heating said pads to modify their geometry, and thus form the lenses of the second array.

According to an embodiment, the exposure by lithography is performed through the lenses of the first array.

According to an embodiment, the second lens array is formed by imprinting.

According to an embodiment, the two lens arrays are formed separately and then assembled by means of an adhesive film.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates, in a cross-section view, an embodiment of an image acquisition system;

FIG. 2 illustrates, in a cross-section view, a step of a first implementation mode of an angular filter manufacturing method;

FIG. 3 illustrates, in a cross-section view, another step of the angular filter manufacturing method according to the first implementation mode;

FIG. 4 illustrates, in a cross-section view, another step of the angular filter manufacturing method according to the first implementation mode;

FIG. 5 illustrates, in a cross-section view, another step of the angular filter manufacturing method according to the first implementation mode;

FIG. 6 illustrates, in a cross-section view, another step of the angular filter manufacturing method according to the first implementation mode;

FIG. 7 illustrates, in a cross-section view, another step of the angular filter manufacturing method according to the first implementation mode;

FIG. 8 illustrates, in a cross-section view, another step of the angular filter manufacturing method according to the first implementation mode;

FIG. 9 illustrates, in a cross-section view, a step of a second implementation mode of an angular filter manufacturing method;

FIG. 10 illustrates, in a cross-section view, another step of the angular filter manufacturing method according to the second implementation mode;

FIG. 11 illustrates, in a cross-section view, another step of the angular filter manufacturing method according to the second implementation mode;

FIG. 12 illustrates, in a cross-section view, another step of the angular filter manufacturing method according to the second implementation mode;

FIG. 13 illustrates, in a cross-section view, another step of the angular filter manufacturing method according to the second implementation mode;

FIG. 14 illustrates, in a cross-section view, another step of the angular filter manufacturing method according to the second implementation mode;

FIG. 15 illustrates, in a cross-section view, another step of the angular filter manufacturing method according to the second implementation mode;

FIG. 16 illustrates, in a cross-section view, a step of a third implementation mode of an angular filter manufacturing method;

FIG. 17 illustrates, in a cross-section view, another step of the angular filter manufacturing method according to the third implementation mode;

FIG. 18 illustrates, in a cross-section view, another step of the angular filter manufacturing method according to the third implementation mode;

FIG. 19 illustrates, in a cross-section view, another step of the angular filter manufacturing method according to the third implementation mode;

FIG. 20 illustrates, in a cross-section view, a variant of the steps of FIGS. 18 and 19;

FIG. 21 illustrates, in a cross-section view, a step of a fourth implementation mode of an angular filter manufacturing method;

FIG. 22 illustrates, in a cross-section view, another step of the angular filter manufacturing method according to the fourth implementation mode;

FIG. 23 illustrates, in a cross-section view, another step of the angular filter manufacturing method according to the fourth implementation mode; and

FIG. 24 illustrates, in a cross-section view, a variant of the step of FIG. 23.

### DESCRIPTION OF THE EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the forming of the image sensor and of the elements other than the angular filter has not been detailed, the described embodiments and implementation modes being compatible with the usual forming of the sensor and of these other elements.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless otherwise specified, when reference is made to absolute positional qualifiers, such as the terms “front”, “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

In the following description, a layer or a film is called opaque to a radiation when the transmittance of the radiation through the layer or the film is smaller than 10%. In the following description, a layer or a film is called transparent to a radiation when the transmittance of the radiation through the layer or the film is greater than 10%. According to an embodiment, for a same optical system, all the elements of the optical system which are opaque to a radiation have a transmittance which is smaller than half, preferably smaller than one fifth, more preferably smaller than one tenth, of the lowest transmittance of the elements of the optical system transparent to said radiation. In the rest of the disclosure, the expression “useful radiation” designates the electromagnetic radiation crossing the optical system in operation. In the following description, “micrometer-range optical element” designates an optical element formed on a surface of a support having a maximum dimension, measured parallel to said surface, greater than 1 μm and smaller than 1 mm. In the following description, a film or a layer is said to be oxygen-tight when the permeability of the film or of the layer to oxygen at 40° C. is smaller than 1.10⁻¹cm³/(m²*day). The permeability to oxygen may be measured according to the ASTM D3985 method entitled “Standard Test Method for Oxygen Gas Transmission Rate Through Plastic Film and Sheeting Using a Coulometric Sensor”. In the following description, a film or a layer is said to be water-tight when the permeability of the film or of the layer to water at 40° C. is smaller than 1.10⁻¹g/ (m²*day). The permeability to water may be measured according to the ASTM F1249 method entitled “Standard Test Method for Water Vapor Transmission Rate Through Plastic Film and Sheeting Using a Modulated Infrared Sensor”.

Embodiments of optical systems will not be described for optical systems comprising an array of micrometer-range optical elements in the case where each micrometer-range optical element corresponds to a micrometer-range lens, or microlens formed of two diopters. It should however be clear that these embodiments may also be implemented with other types of micrometer-range optical elements, where each micrometer-range optical element may for example correspond to a micrometer-range Fresnel lens, to a micrometer-range index gradient lens, or to a micrometer-range diffraction grating.

In the following description, “visible light” designates an electromagnetic radiation having a wavelength in the range from 400 nm to 700 nm and “infrared radiation” designates an electromagnetic radiation having a wavelength in the range from 700 nm to 1 mm. In infrared radiation, one can particularly distinguish near infrared radiation having a wavelength in the range from 700 nm to 1.7 μm.

To simplify the description, unless otherwise specified, a manufacturing step is designated in the same way as the structure obtained at the end of the step.

FIG. 1 illustrates in a cross-section view an embodiment of an image acquisition system 1.

The acquisition system 1 shown in FIG. 1 comprises, from bottom to top in the orientation of the drawing, an image sensor 11 and an angular filter 13.

Image sensor 11 comprises an array of photon sensors 111, also called photodetectors. Photodetectors 111 may be covered with a protective coating, not shown. Image sensor further comprises conductive tracks and switching elements, particularly transistors, not shown, enabling to select photodetectors 111. Photodetectors 111 may be made of organic materials. Photodetectors 111 may correspond to organic photodiodes (OPD), to organic photoresistors, to amorphous or single-crystal silicon photodiodes associated with an array of TFT (Thin Film Transistor) or CMOS (Complementary Metal Oxide Semiconductor) transistors.

According to an embodiment, each photodetector 111 is adapted to detecting visible light and/or infrared radiation.

Acquisition system 1 further comprises units, not shown, for processing the signals supplied by image sensor 11, for example comprising a microprocessor.

Angular filter 13 comprises, from top to bottom, in the orientation of FIG. 1:
a first array of plano-convex lenses 131;
a first substrate or support 133;
a first layer 135 of openings or holes 137;
a second layer 139 that may comprise a planarization layer and/or another substrate and/or an adhesive film; and
a second array of plano-convex lenses 141 used for the collimation of the light transmitted by the filter, the planar surfaces of lenses 141 facing the planar surfaces of lenses 131.

The planar surfaces of the lenses 131 of the first array and the planar surfaces of the lenses 141 of the second array face one another.

The diameter of the lenses 131 of the first array is preferably greater than the diameter of the lenses 141 of the second array.

Each opening 137 is preferably associated with a single lens 131 of the first array. The optical axes 143 of lenses 131 are preferably aligned with the centers of the openings 137 of first layer 135. The diameter of the lenses 131 of the first array is preferably greater than the maximum cross-section length (measured perpendicularly to axes 143) of openings 137.

In the embodiment shown in FIG. 1, the number of lenses 131 of the first array is equal to the number of lenses 141 of the first array. The lenses 131 of the first array and the lenses 141 of the second array are aligned by their optical axes 143.

As a variant, the number of lenses 141 of the second array is larger than the number of lenses 131 of the first array.

In the example of FIG. 1, each photodetector 111 is shown as being associated with a single opening 137, the center of each photodetector 111 being centered with the center of the opening 137 with which it is associated. In practice, the resolution of angular filter 13 is at least twice greater than the resolution of image sensor 11. In other words, system 1 comprises at least twice more lenses 131 (or openings 137) as photodetectors 111. Thus, a photodiode 111 is associated with at least two lenses 131 (or openings 137).

Angular filter 13 is adapted to filtering the incident radiation according to the incidence of the radiation with respect to the optical axes 143 of the lenses 131 of the first array. Angular filter 13 adapted so that each photodetector 111 of image sensor 11 only receives the rays having respective incidences with respect to the respective optical axes 143 of the lenses 131 associated with photodetectors 111 smaller than a maximum incidence angle smaller than 45° preferably smaller than 30°, more preferably smaller than 10°, more preferably still smaller than 4°. Angular filter 13 is capable blocking the rays of the incident radiation having respective incidences relative to the optical axes 143 of the lenses 131 of filter 13 greater than the maximum incidence angle.

The rays emerge from lenses 131 and from layer 135 with an angle a relative to the respective direction of the rays incident to lenses 131. Angle a is specific to a lens 131 and depends on the diameter thereof and on the focal distance of this same lens 131.

At the output of layer 135, the rays cross 139 and then meet the lenses 141 of the second array. The rays are thus deviated, as they come out of lenses 141, by an angle β relative to the respective directions of the rays incident on lenses 141. Angle β is specific to a lens 141 and depends on the diameter thereof and on the focal distance of this same lens 141.

The total divergence angle corresponds to the deviations successively generated by lenses 131 and by lenses 141. The lenses 141 of the second array are selected so that the total divergence angle is for example smaller than or equal to approximately 5°.

The embodiment shown in FIG. 1 illustrates an ideal configuration where the image focal planes of the lenses 131 of the first array are the same as the object focal planes of the lenses 141 of the second array. The shown rays, arriving parallel to the optical axis, are focused onto the image focus of lens 131 or object focus of lens 141. The rays which emerge from lens 141 thus propagate parallel to the optical axis thereof. The total divergence angle is, in this case, zero.

In the absence of a second lens array 141, if the divergence angle is too large, certain rays emerging from a lens 131 risk not being absorbed by walls 136 between the openings 137 of layer 135. They then risk illuminating a plurality of photodetectors 111. This generates a loss of resolution in the quality of the resulting image.

An advantage that appears is that the presence of a second array of lenses 141 generates a decrease in the divergence angle at the output of angular filter 13. The decrease of the divergence angle enables to decrease risks of intersection of the rays emerging at the level of image sensor 11.

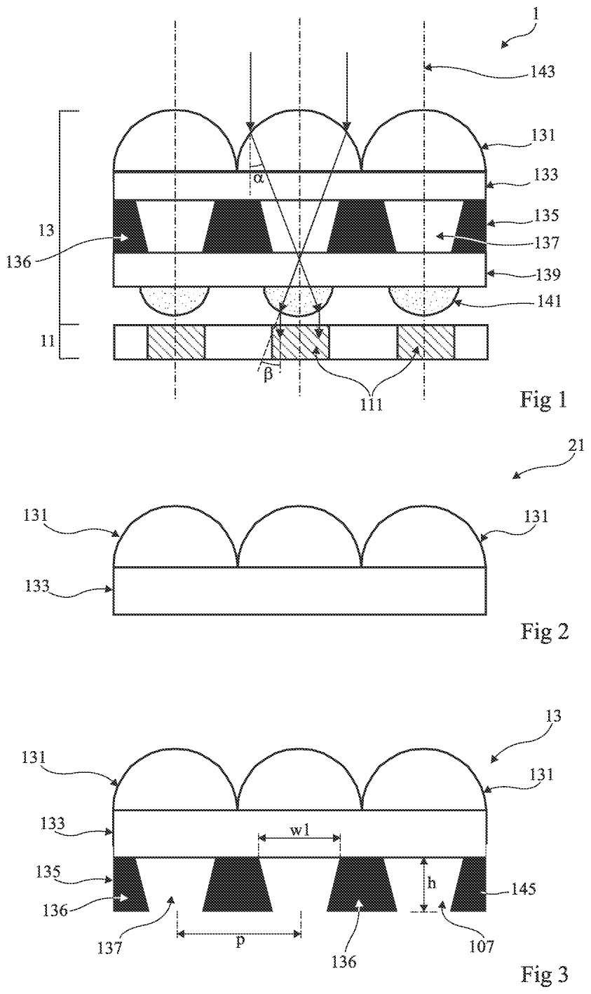

FIGS. 2 to 8 schematically and partially illustrate successive steps of an example of an angular filter manufacturing method according to a first implementation mode.

FIG. 2 illustrates, in a cross-section view, a step of the first implementation mode of the angular filter manufacturing method.

More particularly, FIG. 2 partially and schematically shows an initial structure or stack 21 of the first array of lenses or microlenses 131 and of first substrate 133.

Substrate 133 may be made of a clear polymer which does not absorb at least the considered wavelengths, here in the visible and infrared range. The polymer may in particular be made of polyethylene terephthalate PET, poly(methyl methacrylate) PMMA, cyclic olefin polymer (COP), polyimide (PI), polycarbonate (PC). The thickness of substrate 133 may for example vary from 1 to 100 μm, preferably from 10 to 100 μm. Substrate 133 may correspond to a colored filter, to a polarizer, to a half-wave plate or to a quarter-wave plate.

Microlenses 131, on top of and in contact with substrate 133, may be made of silica, of PMMA, of positive resist, of PET, of polyethylene naphthalate (PEN), of COP, of polydimethylsiloxane (PDMS)/silicone, of epoxy resin, or of acrylate resin. Microlenses 131 may be formed by creeping of resist blocks. Microlenses 131 may further be formed by imprinting on a layer of PET, PEN, COP, PDMS/silicone, of epoxy resin, or of acrylate resin.

Microlenses 131 are converging lenses, each having a focal distance f in the range from 1 μm to 100 μm, preferably from 1 μm to 70 μm. According to an embodiment, all the microlenses 131 are substantially identical.

In the following description, the upper surface of the structure is considered, in the orientation of FIG. 2, as being the front side and the lower surface of the structure, in the orientation of FIG. 2, is considered as being the back side.

FIG. 3 illustrates, in a cross-section view, another step of the angular filter manufacturing method according to the first implementation mode.

More particularly, FIG. 3 illustrates in a partial simplified view a step of forming of the layers 135 of a first resin 145, comprising the array of openings 137, on the back side of the structure obtained at the end of the step of FIG. 2.

Call “h” the thickness of layer 135 measured from support 133. Layer 135 is for example opaque to the radiation detected by the photodetectors (111, FIG. 1), for example absorbing and/or reflective with respect to the radiation detected by the photodetectors. Layer 135 absorbs in the visible and/or near infrared and/or infrared range. Layer 135 may be opaque to the radiation, in the range from 450 nm to 570 nm, used for imaging (biometry and fingerprint imaging).

In FIG. 3, openings 137 are shown with a trapezoidal cross-section, in a cross-section view. Generally, the cross-section of openings 137, in cross-section view, may be square, triangular, rectangular. Further, the cross-section of openings 137, in top view, may be circular, oval, or polygonal, for example, triangular, square, rectangular, trapezoidal, or funnel-shaped. The cross-section of openings 137 in the top view is preferably circular.

According to an embodiment, openings 137 are arranged in rows and in columns. Openings 137 may have substantially the same dimensions. Call “w1” the diameter of openings 137 (measured at the base of the openings, that is, at the interface with substrate 133). According to an embodiment, openings 137 are regularly arranged in rows and in columns. Call “p” the repetition pitch of holes 137, that is, the distance in top view between centers of two successive holes 137 of a row or of a column.

Openings 137 are preferably formed so that each microlens 131 is in front of a single opening 137 and that each opening 137 is topped with a single microlens 137. The center of a microlens 131 is for example aligned with the center of opening 137 which is associated therewith. The diameter of each lens 131 is preferably greater than the diameter w1 of each opening 137 with which lens 131 is associated.

Pitch p may be in the range from 5 μm to 50 μm, for example equal to approximately 15 μm. Height h may be in the range from 1 μm to 1 mm, preferably in the range from 12 μm to 15 μm. Width wl may preferably be in the range from 5 μm to 50 μm, for example equal to approximately 10 μm.

An embodiment of a method of manufacturing layer 135 comprising the array of openings 137 comprises the steps of:
depositing the layer 135 of the first resin 145, on the back side of substrate 133, by centrifugation or coating;
forming openings 137 in layer 135 by exposure of first resin 145 (photolithography), on its front side, to light collimated through the mask formed by the array of microlenses 131; and
removing, by development, the exposed portions of resin 145.

According to this embodiment, microlenses 131 and substrate 133 are preferably made of materials which are transparent or partially transparent, that is, transparent in a portion of the spectrum considered for the targeted field, for example, imaging, over the wavelength range corresponding to the wavelengths used during the exposure.

Another embodiment of a method of manufacturing layer 135, comprising the array of openings 137, comprises the following steps:
depositing the layer 135 of the first resin 145, on the back side of substrate 133, by centrifugation or coating;

1forming openings 137 in layer 135 by exposure of resin 145, through its back side, to light collimated through a mask; and
removing by development the exposed portions of resin 145.

This embodiment requires a previous alignment of the openings, drawn on the mask, with lenses 131 to form openings 137 aligned with lenses 131.

In practice, this alignment is performed by means of alignment marks (preferably at least four alignment marks) distributed across the entire surface of the structure.

Another implementation mode of a method of manufacturing layer 135, comprising the array of openings 137, comprises the steps of:
forming, on the back side of substrate 133 and by photolithographic etch steps, a mold made of a transparent negative sacrificial resin (not shown in FIG. 3) of the desired shape of openings 137;
filling the mold with first resin 145; and

Removing the sacrificial resin mold, for example, by a “lift-off” method.

This embodiment also requires a previous alignment of the openings, drawn on the mask, with lenses 131 to form openings 137 aligned with lenses 131.

An implementation mode of a method of manufacturing layer 135, comprising the array of openings 137, comprises the following steps:
depositing layer 135 of resin 145, on the back side of substrate 133, by coating or centrifugation; and
perforating layer 135 of resin 145 to form openings 137.

This embodiment also requires a previous alignment of lenses 131 with the perforation tool to form openings 137 aligned with lenses 131.

The perforation may be performed by using a micro-perforation tool for example comprising micro-needles to obtain accurate dimensions of holes 137.

As a variant, the perforation of layer 135 may be performed by laser ablation.

According to an embodiment, resin 145 is positive resist, for example, a colored or black DNQ-Novolac resin, or a DUV (Deep Ultraviolet) resist. DNQ-Novolac resists are based on a mixture of diazonaphtoquinone (DNQ) and of a novolac resin (phenolformaldehyde resin). DUV resists may comprise polymers based on polyhydroxystyrenes.

According to another embodiment, resin 145 is a negative resist. Examples of negative resists are epoxy polymer resins, for example, the resin commercialized under name SU-8, acrylate resins, and off-stoichiometry thiolene (OSTE) polymers.

According to another embodiment, resin 145 is based on a laser machinable material, that is, a material likely to degrade under the action of a laser radiation. Examples of laser machinable materials are graphite, plastic materials such as PMMA, acrylonitrile butadiene styrene (ABS), or dyed plastic films such PET, PEN, COPs, and PIs.

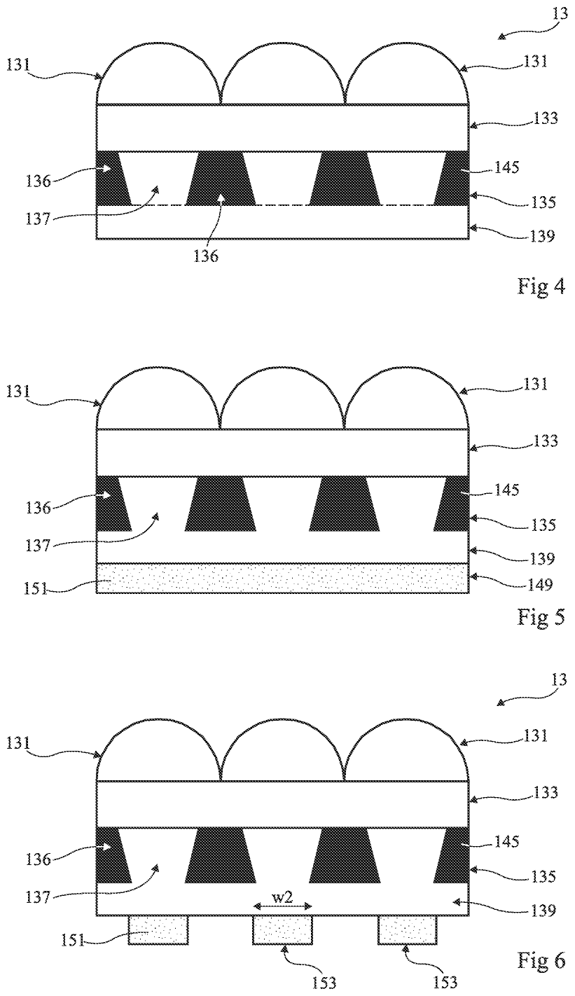

FIG. 4 illustrates, in a cross-section view, another step of the angular filter manufacturing method according to the first implementation mode.

More particularly, FIG. 4 illustrates in a partial simplified view a step of planarization, by the deposition of a second layer 139, on the back side of the structure obtained at the end of the steps of FIGS. 2 and 3.

Optionally, openings 137 are filled with air or with a filling material at least partially transparent to the radiation detected by the photodetectors (111, FIG. 1), for example, PDMS, an epoxy or acrylate resin, or a resin known under trade name SU8. As a variant, openings 137 may be filled with a partially clear material, that is absorbing in a portion of the spectrum considered for the targeted field, for example, imaging, to chromatically filter the rays angularly filtered by angular filter 13.

After the step illustrated in FIG. 3 or after the optional filling of openings 137, the back side of the structure is fully covered with second layer 139. In other words, first layer 135 is covered with second layer 139. The lower surface of second layer 139 is, after this step, substantially planar. Openings 137 are thus filled with the second layer 139 if the step of filling of openings 137 has not been previously carried out.

The material of layer 139 is preferably at least partially transparent to the radiation detected by the photodetectors (111, FIG. 1), for example, PDMS, an epoxy or acrylate resin, or a resin known under trade name SU8. The filling material used during the optional filling of openings 137 and the material of layer 139 may have the same composition or different compositions.

FIG. 5 illustrates, in a cross-section view, another step of the angular filter manufacturing method according to the first implementation mode.

More particularly, FIG. 5 illustrates, in a partial simplified view, a step of deposition of a film 149 of a second resin 151, on the back side of the structure obtained at the end of the steps of FIGS. 2 to 4.

According to an implementation mode, the back side of the structure is integrally covered (full plate), and in particular layer 139 is covered with the film 149 of second resin 151. Second resin 151 is preferably positive.

The thickness of the film is substantially constant across the entire structure. The thickness is for example in the range from 1 μm to 20 μm, preferably from 12 μm to 15 μm.

As an alternative implementation, layer 149 may be deposited on a support film (not shown) and then the assembly of layer 149 and of said film on the structure obtained at the end of the steps of FIGS. 2 to 4 may be laminated. Layer 149 may be deposited according to this alternative implementation from as soon the end of the step illustrated in FIG. 3.

FIG. 6 illustrates, in a cross-section view, another step of the angular filter manufacturing method according to the first implementation mode.

More particularly, FIG. 6 illustrates, in a partial simplified view, a step of removal of a portion of layer 149 to form pads 153 of second resin 151.

Pads 153 are formed so that they have, for example, in top view, a square or circular shape, preferably circular. The pads have a diameter w2 in the range, for example, from 2 μm to the diameter of lenses 131. The number of pads 153 preferably corresponds to the number of lenses 131 of the first array.

An embodiment of a method of manufacturing pads 153, from layer 149, comprises the following steps:
forming pads 153 in layer 149 by exposure of second resin 151, on its front side, to light collimated through the mask formed by the array of microlenses 131 and openings 137; and
removing by development the non-exposed portions of resin 151.

According to this embodiment, microlenses 131, substrate 133, and layer 139 are preferably made of materials clear over the wavelength range corresponding to the wavelengths used during the exposure.

Another embodiment of a method of manufacturing pads 153, from layer 151, comprises the following steps:
forming pads 153 in layer 149 by exposure of resin 151, on its back side, to light collimated through a mask; and
removing by development the non-exposed portions of resin 151.

This embodiment requires a previous alignment of the pads 153 drawn on the mask with lenses 131 (and openings 137) to form pads 153 aligned with lenses 131 (and openings 137).

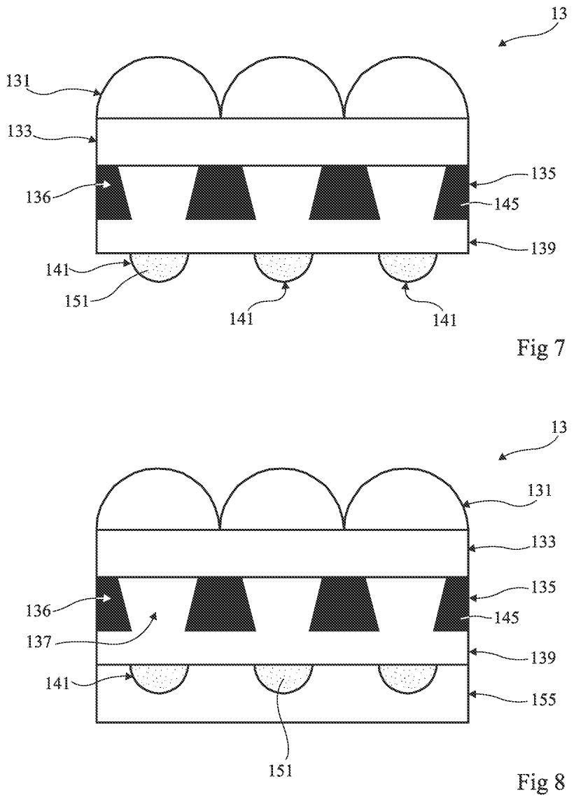

FIG. 7 illustrates, in a cross-section view, another step of the angular filter manufacturing method according to the first implementation mode.

More particularly, FIG. 7 illustrates, in a partial simplified view, a step of heating of the structure obtained at the end of the steps of FIGS. 2 to 6.

According to an implementation mode, the structure is heated to deform pads 153 of resin 151. Indeed, by action of the heat, pads 153 deform by creeping to form lenses 141. The temperature, during this step, is for example in the range from 100 to 200° C.

As a variant, pads 153 are exposed to UVs to be deformed and to form lenses 141. The aperture angle of the UV source enables to modify the curvature of lenses 141.

At the end of the step illustrated in FIG. 7, lenses 141 have, for example, a spherical or aspherical cap shape.

FIG. 8 illustrates, in a cross-section view, another step of the angular filter manufacturing method according to the first implementation mode.

More particularly, FIG. 8 illustrates in a partial simplified view a step of deposition of a third layer 155, on the back side of the structure obtained at the end of the steps of FIGS. 2 to 7.

The back side of the structure is integrally covered (full plate) and, in particular, lenses 141 and second layer 139 are covered with third layer 155.

Third layer 155 and second layer 139 may be of same composition or of different compositions.

Third layer 155 has, preferably, an optical index smaller than the optical index of second resin 151.

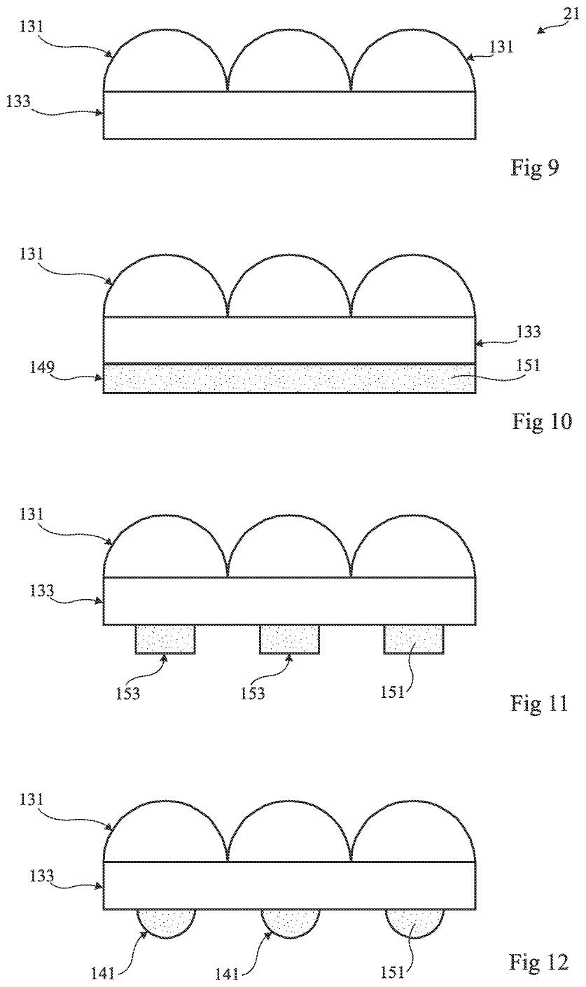

FIGS. 9 to 15 schematically and partially illustrate successive steps of an example of the angular filter manufacturing method according to a second implementation mode.

The second implementation mode differs from the first implementation mode by the fact that the first lens array 131 is formed in contact with substrate 133 and before the forming of the first layer 135 comprising the array of openings 137.

FIG. 9 illustrates, in a cross-section view, a step of the second implementation mode of the angular filter manufacturing method.

More particularly, FIG. 9 illustrates in a partial simplified view an initial structure identical to the initial structure of the method according to the first implementation mode, shown in FIG. 2.

FIG. 10 illustrates, in a cross-section view, another step of the angular filter manufacturing method according to the second implementation mode.

More particularly, FIG. 10 illustrates in a partial simplified view a step of deposition of the film 149 of the first implementation mode on the back side of the structure obtained at the end of the step of FIG. 9.

This step is substantially identical to the step illustrated in FIG. 5 of the method according to the first implementation mode, with the difference that, in the step illustrated in FIG. 10, film 149 covers substrate 133.

FIG. 11 illustrates, in a cross-section view, another step of the angular filter manufacturing method according to the second implementation mode.

FIG. 12 illustrates, in a cross-section view, another step of the angular filter manufacturing method according to the second implementation mode.

More particularly, FIGS. 11 and 12 illustrate in partial simplified views a step of forming of second lens array 141 on the back side of the structure obtained at the end of the step of FIG. 10, from film 149.

These two steps are substantially identical to the steps respectively illustrated in FIGS. 6 and 7 of the method according to the first implementation mode.

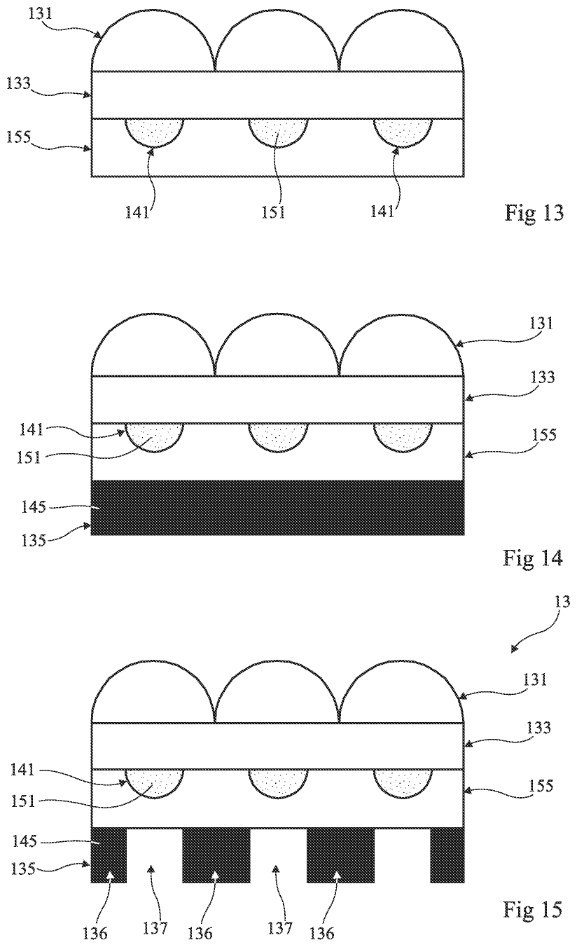

FIG. 13 illustrates, in a cross-section view, another step of the angular filter manufacturing method according to the second implementation mode.

More particularly, FIG. 13 illustrates in a partial simplified view a step of deposition of a third layer 155 having an optical index lower than the optical index of second resin 151, on the back side of the structure obtained at the end of the steps of FIGS. 9 to 12.

The back side of the structure is integrally covered (full plate) and, in particular, lenses 141 and substrate 133 are covered with third layer 155.

FIG. 14 illustrates, in a cross-section view, another step of the angular filter manufacturing method according to the second implementation mode.

FIG. 15 illustrates, in a cross-section view, another step of the angular filter manufacturing method according to the second implementation mode.

More particularly, FIGS. 14 and 15 illustrate in partial simplified views a step of forming of first layer 135, comprising the array of openings 137, on the back side of the structure obtained at the end of the steps of FIGS. 9 to 13.

These two steps are substantially identical to the step illustrated in FIG. 3 of the method according to the first implementation mode, with the difference that first layer 135 is formed on third layer 155.

These steps may be followed with a step of deposition of a second layer substantially identical to the step of deposition of the second layer 139 of FIG. 7 of the method according to the first implementation mode.

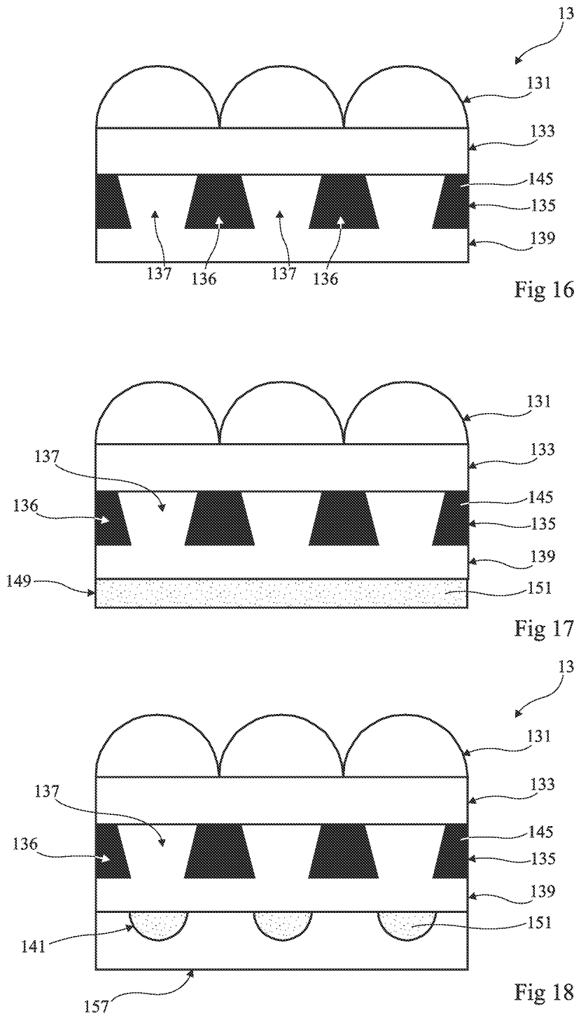

FIGS. 16 to 19 schematically and partially illustrate successive steps of an example of the angular filter manufacturing method according to a third implementation mode.

The third implementation mode differs from the first implementation mode by the manufacturing mode of second lens array 141.

FIG. 16 illustrates, in a cross-section view, a step of the third implementation mode of the angular filter manufacturing method.

More particularly, FIG. 16 illustrates in a partial simplified view a step of forming of a structure substantially identical to the structure illustrated in FIG. 4 of the method according to the first implementation mode. The structure illustrated in FIG. 16 thus substantially corresponds to the result of the implementation of the steps of FIGS. 2 to 4 of the method according to the first implementation mode.

FIG. 17 illustrates, in a cross-section view, another step of the angular filter manufacturing method according to the third implementation mode.

More particularly, FIG. 17 illustrates, in a partial simplified view, a step of deposition of the film 149 of second resin 151 on the back side of the structure obtained at the end of the step of FIG. 16.

This step is substantially identical to the step illustrated in FIG. 5 of the method according to the first implementation mode.

In the present implementation mode, second resin 151 is preferably based on non-crosslinked epoxy and/or acrylate.

FIG. 18 illustrates, in a cross-section view, another step of the angular filter manufacturing method according to the third implementation mode.

More particularly, FIG. 18 illustrates, in a partial simplified view, a step of forming of the second lens array 141 from film 149.

In this step, second lens array 141 is formed by imprinting. More precisely, film 149, of constant initial thickness, is deformed by pressure of a mold 157 on the structure. The mold 157 used preferably has the shape of the imprint of lens array 141. During the pressure, the structure is, at the same time, exposed to a light radiation, for example UV, or to a heat source (thermal molding) enabling to crosslink, and thus to cure, second resin 151. Second resin 151 then takes the shape inverse to that of mold 157.

In practice, the structure may be, during this step, mounted on a protection film, by its front side, to avoid damaging first lens array 131.

The structure illustrated in FIG. 18 corresponds to the structure obtained at the end of the step described hereabove, mold 157 being always in contact with resin 151.

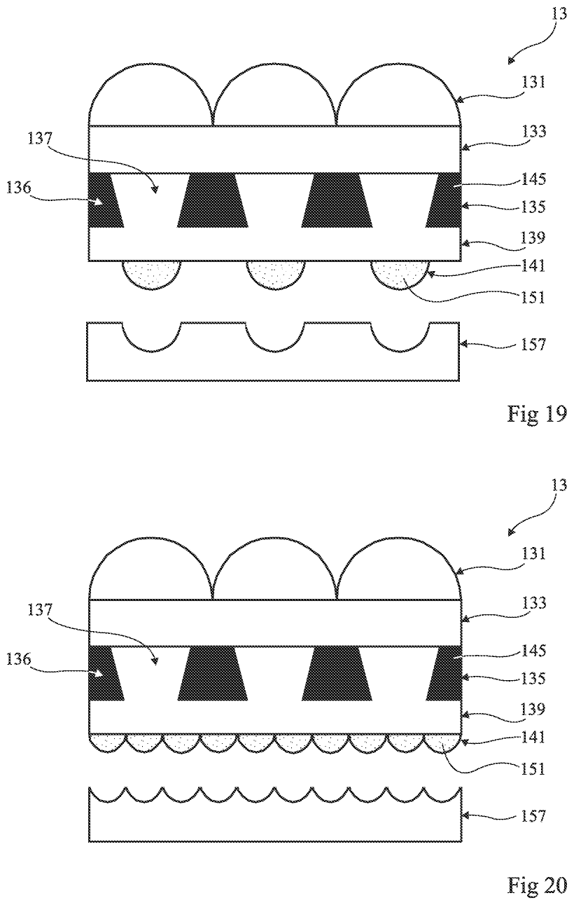

FIG. 19 illustrates, in a cross-section view, another step of the angular filter manufacturing method according to the third implementation mode.

More particularly, FIG. 19 illustrates, in a partial simplified view, a step of removal of mold 157, present on the structure obtained at the end of the step of FIG. 18.

Mold 157 is removed in this step to release second lens array 141.

In practice, at the end of this step, lenses 141 are not necessarily separated from one another. Indeed, the latter may be coupled by a crosslinked film originating from film 149. This phenomenon is particularly due to the defects present at the inner surface of mold 157, to planarization defects of layer 139.

This step requires a previous alignment of mold 157 with lenses 131 (and openings 137) to form lenses 141 aligned with lenses 131 (and openings 137).

FIG. 20 illustrates, in a cross-section view, a variant of the steps of FIGS. 18 and 19.

More particularly, FIG. 20 illustrates, in a partial simplified view, an alternative embodiment of the steps of FIGS. 18 and 19.

The step illustrated in FIG. 20 differs from the steps illustrated in FIGS. 18 and 19 by the fact that the number of lenses 141 of the second array is not identical to the number of lenses 131 of the first array. The number of lenses 141 is preferably greater than the number of lenses 131. As an example, the number of lenses 141 is at least twice greater than the number of lenses 131.

The optical axis 143 (FIG. 1) of each lens 141 is, in this case, not necessarily aligned with the optical axis 143 (FIG. 1) of a lens 131.

This variant thus requires no previous alignment of mold 157 with lenses 131 (and openings 137).

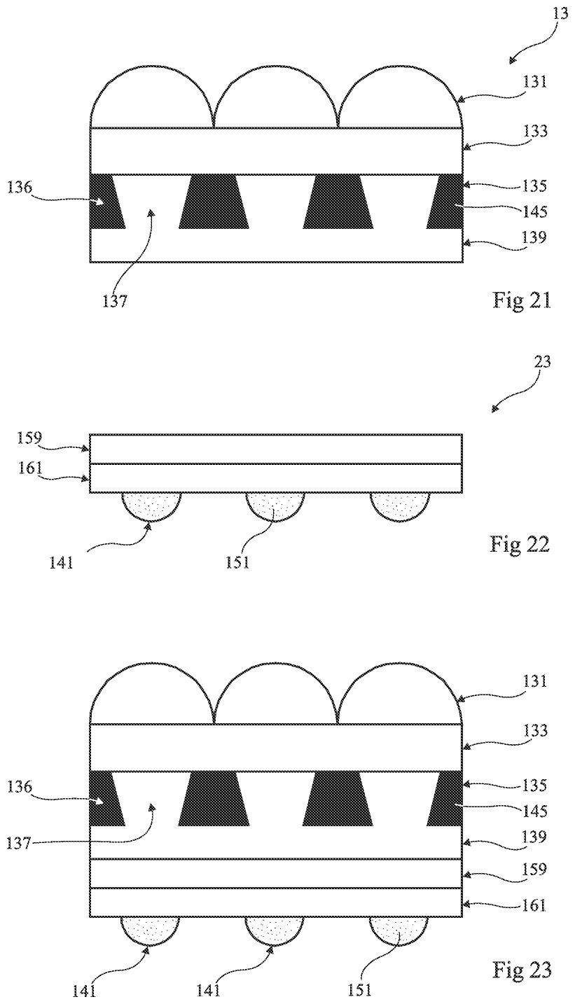

FIGS. 21 to 24 schematically and partially illustrate successive steps of an example of the angular filter manufacturing method according to a fourth implementation mode.

The fourth implementation mode differs from the first implementation mode by the fact that the two arrays of lenses 131 and 141 are formed separately and then assembled by an adhesive.

FIG. 21 illustrates, in a cross-section view, a step of a fourth implementation mode of an angular filter manufacturing method.

More particularly, FIG. 21 illustrates, in a partial simplified view, a step of forming of a structure substantially identical to the structure illustrated in FIG. 4 of the method according to the first implementation mode.

FIG. 22 illustrates, in a cross-section view, another step of the angular filter manufacturing method according to the fourth implementation mode.

More particularly, FIG. 22 illustrates a step of forming of a stack 23, comprising, from top to bottom:
an adhesive film 159;
a second substrate 161; and
second lens array 141.

Second substrate 161 is substantially identical to the first substrate 133 illustrated in FIG. 2 of the method according to the first implementation mode.

According to an embodiment, the forming of lens array 141 is substantially identical to the forming of the lens array 141 discussed in the steps illustrated in FIGS. 5 to 7 of the method according to the first implementation mode, with the difference that, at the step of FIG. 22, second lens array 141 is formed on substrate 161. Second lens array 141 being formed on a structure which does not comprise firs lens array 131, lenses 141 may however not be formed, by photolithographic etching, by action of the light collimated through the mask formed by the first lens array 131.

According to another embodiment, the forming of lens array 141 is substantially identical to the forming of the lens array 141 discussed in the steps illustrated in FIGS. 17 to 20 of the method according to the third implementation mode.

FIG. 23 illustrates, in a cross-section view, another step of the angular filter manufacturing method according to the fourth implementation mode.

More particularly, FIG. 23 illustrates a step of assembly of the two structures illustrated in FIG. 21 and in FIG. 22.

In this step, stack 23 is positioned and glued to the back side of the structure illustrated in FIG. 21 by the adhesive film 159 located on the front side of stack 23.

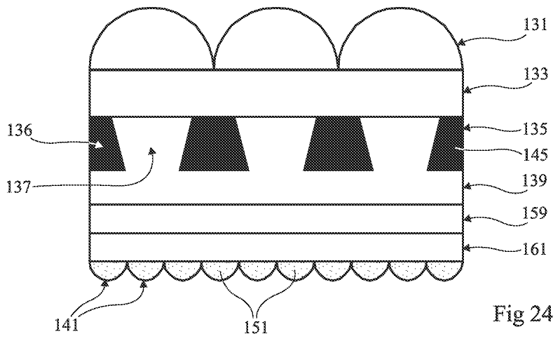

FIG. 24 illustrates, in a cross-section view, a variant of the step of FIG. 23.

More particularly, FIG. 24 illustrates, in a partial simplified view, an alternative embodiment of the steps of FIGS. 22 and 23.

The structure illustrated in FIG. 24 differs from the structure illustrated in FIG. 23 by the fact that the number of lenses 141 of the second array is not identical to the number of lenses 131 of the first array. The number of lenses 141 is preferably greater than the number of lenses 131.

Lenses 141, illustrated in FIG. 24, are substantially identical to the lenses 141 illustrated in FIG. 20 of the method according to the third implementation mode.

This variant thus requires no previous alignment of lens array 141 with lens array 131 (and openings 137).

Various embodiments and variants have been described. Those skilled in the art will understand that certain features of these various embodiments and variants may be combined, and other variants will occur to those skilled in the art. In particular, the second and third implementation modes may be combined and the variant illustrated in FIG. 20 in the third implementation mode may transpose to the first and second implementation modes. Further, the described embodiments are for example not limited to the examples of dimensions and of materials mentioned hereabove.

Finally, the practical implementation of the embodiments and variants described herein is within the capabilities of those skilled in the art based on the functional indications provided hereinabove.

1. An angular filter comprising:
a first array of plano-convex lenses;
a second array of plano-convex lenses located between the first lens array and an image sensor; and
an array of openings,
the planar surfaces of the lenses of the first array and of the second array facing one another and the number of lenses of the second array being greater than the number of lenses of the first array.

2. The angular filter according to claim 1, wherein the array of openings is formed in a layer made of a first resin opaque in the visible and infrared ranges.

3. The angular filter according to claim 1, wherein the openings of the array are filled with air or with a material at least partially clear in the visible and infrared ranges.

4. The angular filter according to claim 1, wherein the optical axis of each lens of the first array is aligned with the optical axis of a lens of the second array and the center of an opening of the array.

5. The angular according to claim 1, wherein each opening of the array is associated with a single lens of the first array.

6. The angular filter according to claim 1, wherein the image focal planes of the lenses of the first array coincide with the object focal planes of the lenses of the second array.

7. The angular filter according to claim 1, wherein the lenses of the first array have a diameter greater than that of the lenses of the second array.

8. The angular filter according to claim 1, wherein the array of openings is located between the first lens array and the second lens array.

9. The angular filter according to claim 1, wherein the second lens array is located between the first lens array and the array of openings.

10. The angular filter according to claim 1, wherein the lenses of the first array are on top of and in contact with a substrate.

11. A method of manufacturing an angular filter according to claim 1, comprising the steps of:
depositing a film of resist;
forming by photolithography pads of the resist; and
heating said pads to modify their geometry, and thus form the lenses of the second array.

12. The method according to claim 11, wherein the exposure by photolithography is performed through the lenses of the first array.

13. A method of manufacturing an angular filter according to claim 1, comprising the steps of forming the second lens array by imprinting.

14. The method according to claim 11, wherein the two lens arrays are formed separately and then assembled by means of an adhesive film.

15. The method according to claim 13, wherein the two lens arrays are formed separately and then assembled by means of an adhesive film.
